(19) United States
(12) Patent Application Publication
(10) Pub. No.: US 2012/0319438 A1
(43) Pub. Date: Dec. 20, 2012

(54) INFANT CAR SEAT

(76) Inventor: Tae Hyung Kim, Busan (KR)

(21) Appl. No.: 13/581,768

(22) PCT Filed: May 3, 2011
(86) PCT No.: PCT/KR2011/003316

§ 371 Date: Aug. 29, 2012

(30) Foreign Application Priority Data
May 3, 2010 (KR) 20-2010-0004660

(51) Int. Cl. A47B 83/02; B60N 2/26

(52) U.S. Cl. 297/163; 297/256.16

(57) ABSTRACT

An infant car seat to be strapped to a seat of a car, the infant car seat including a main body to be strapped to a seat of a car; an infant carrier accommodated in the main body; and a fixing unit for fixing the infant carrier to the main body. The infant carrier is not necessary to form a complicated and durable structure for protection against external shock, and thus the infant car seat according to the present invention provide a lightweight infant carrier for an infant who cannot hold his/her head up yet and the main body for a sitting a grown-up child thereon. Therefore, it is more lightweight and more economical than purchasing an infant carrier and an infant car seat separately.

### TECHNICAL FIELD

The present invention relates to an infant car seat, and more particularly, to an infant car seat, which includes an infant carrier that is accommodated in and detachably fixed to the main body.

### BACKGROUND ART

Korean Patent Application No. 1999-10-0045470 (U.S. Pat. No. 9,177,179) discloses a basket-like infant carrier that can be carried for an infant who cannot hold his/her head up yet. Here, the infant car seat has a durable and complex structure for a possible car crash when the infant car seat is strapped into a car. As a result, the infant car seat is densely and heavily formed, and thus it is uncomfortable for a woman with relatively weak physical strength to move out of a car while carrying her child in the is basket-like infant car seat.

For examples of car equipments for child who has grown up enough to walk by himself or herself, U.S. Pat. No. 7,370,912 discloses a chair-like child car seat that may be strapped with a seat belt of a car and U.S. Pat. No. 4,662,683 discloses a juvenile car seat including a seat belt to strap a child thereto.

It is expensive to purchase both a portable infant carrier and an infant car seat to be strapped into a car separately.

Korean Patent Application No. 10-2000-0005571 (U.S. Pat. No. 6,659,564) discloses a juvenile safety car seat with size adjusting features. However, the juvenile safety car seat cannot be carried with an infant and it is necessary for a user to directly carry the infant outside a car. Therefore, it may be necessary to purchase a portable infant carrier separately.

### DISCLOSURE OF THE INVENTION

### Technical Solution

The present invention provides an infant car seat, which includes a lightweight portable infant carrier for carrying an infant that cannot hold his/her head up therein and functions to prevent external shocks to the infant carrier in a case of a car crash, wherein the infant car seat can be used without the infant carrier in a case where a child has grown enough to walk by himself or herself.

According to an aspect of the present invention, there is provided an infant car seat to be strapped to a seat of a car, the infant car seat including a main body to be strapped to a seat of a car; an infant carrier accommodated in the main body; and a fixing unit for fixing the infant carrier to the main body.

The infant carrier may be accommodated in a seat back portion that is formed at the main body for sitting a child thereon, the fixing unit may be a pair of attachment screws at which levers are formed at their heads, a first attachment hole, in which screw threads are formed on the inner circumferential surface, is formed in each side of the left and right sides of the infant carrier, a second attachment hole, in which screw threads are formed on the inner circumferential surface, is formed in each side of the left and right sides of the main body, and the first attachment holes and the second attachment holes are combined with each others by the attachment screws, respectively.

According to another aspect of the present invention, there is provided an infant car seat to be strapped to a seat of a car, the infant car seat including a main body, which is to be strapped to a seat of a car and includes a seat back portion that is formed at the main body for sitting a child thereon; a baby's diaper changing table accommodated in the seat back portion; an infant carrier mounted on the baby's diaper changing table; and a fixing unit for fixing the baby's diaper changing table and the infant carrier to the main body.

The fixing unit may be a pair of attachment screws, at which levers are formed at their heads, a first attachment hole, in which screw threads are formed on the inner circumferential surface, is formed in each side of the left and right sides of the infant carrier, a second attachment hole, in which screw threads are formed on the inner circumferential surface, is formed in each side of the left and right sides of the main body, the baby's diaper changing table includes a worktable, which is formed to lay an infant thereon, and side protection plates, which are formed at both side of the worktable, a third attachment hole, in which screw threads are formed on the inner circumferential surface, is formed in each side of the left and right sides of the side protection plates, and the first attachment holes, the second attachment holes, and the third attachment holes are combined with each others by the attachment screws, respectively.

According to another aspect of the present invention, there is provided an infant car seat to be strapped to a seat of a car, the infant car seat including a main body, which is to be strapped to a seat of a car and includes a seat back portion that is formed at the main body for sitting a child thereon; a baby's diaper changing table accommodated in the seat back portion; an infant carrier mounted on the baby's diaper changing table; a first fixing unit for fixing the baby's diaper changing table and the infant carrier to the main body; and a second fixing unit for fixing the infant carrier to the baby's diaper changing table.

The fixing unit may be a pair of attachment screws, at which levers are formed at their heads, a first attachment hole, in which screw threads are formed on the inner circumferential surface, is formed in each side of the left and right sides of the main body, the baby's diaper changing table includes a worktable, which is formed to lay an infant thereon, and side protection plates, which are formed upward at the left and right sides of the worktable, a second attachment hole, in which screw threads are formed on the inner circumferential surface, is formed in each of the left and right sides protection plates, the first attachment holes and the second attachment holes are combined with each others by the attachment screws, respectively, the fixing unit may be a pair of attachment screws, at which levers are formed at their heads, a third attachment hole, in which a screw threads are formed on the inner circumferential surface, is formed in each side of the left and right sides of the infant carrier, the fourth attachment hole, in which a screw threads are formed on the inner circumferential surface, is formed in each side of each front portions of the side protection plates, and the third attachment holes and the fourth attachment holes are combined with each others by the attachment screws, respectively.

A supporting base, which protrudes downward, may be formed on the bottom surface of the worktable of the baby's diaper changing table, whereas an insertion groove, to which the lower portion of the supporting base is inserted, is formed on the top surface of the front portion of the main body.

The infant car seat may further include an auxiliary seat back, which is accommodated in the seat back portion and is fixed by the fixing unit.

The auxiliary seat back may include a seat portion on which a child may sit; a backrest portion which extends upward from the rear portion of the seat portion to which the child can rest his or her back; and each side panels formed at the left and right sides of the seat portion and the backrest portion, wherein the fixing unit may be a pair of attachment screws, at which levers are formed at their heads, a first attachment hole, in which screw threads are formed on the inner circumferential surface, is formed in each side of the left and right sides of the main body, a second attachment hole, in which screw threads are formed on the inner circumferential surface, is formed in each side of locations on the left and right sides panels in correspondence to the attachment holes, and the first attachment holes and the second attachment holes are combined with each others by the attachment screws, respectively.

### ADVANTAGEOUS EFFECTS

According the present invention, since an infant car seat protects an infant carrier from external shock, it is not necessary to form a complicated and durable structure for protection against external shock, and thus the infant car seat according to the present invention may be inexpensive and lightweight.

Furthermore, if a child soils a baby's diaper in a car, the child can be laid on a baby's diaper changing table and the soiled baby's diaper may be replaced conveniently. Furthermore, if an auxiliary seat back is attached to a seat back portion of main body, a child with smaller frame may be stably fixed to the seat. Even when a child has grown enough to walk by himself or herself, the infant car seat itself could still be used. Therefore, it is more economical than purchasing an infant carrier and an infant car seat separately.

### BRIEF DESCRIPTION OF THE DRAWINGS

FIG. 1 is a perspective view of an infant car seat according to an embodiment of the present invention;

FIG. 2 is a diagram showing detachment of a safety belt;

FIG. 3 is a perspective view showing that an infant carrier is combined with the infant car seat of FIG. 1;

FIG. 4 is a perspective view of an infant car seat according to another embodiment of the present invention;

FIG. 5 is a diagram showing a usage of the infant car seat of FIG. 4;

FIG. 6 is a diagram showing another usage of the infant car seat of FIG. 4;

FIG. 7 is a perspective view of an infant car seat according to another embodiment of the present invention;

FIG. 8 is a diagram showing a usage of the infant car seat of FIG. 7;

FIG. 9 is a diagram showing another usage of the infant car seat of FIG. 7;

FIG. 10 is a perspective view of an infant car seat according to another embodiment of the present invention;

FIG. 11 is a diagram showing an usage of the infant car seat of FIG. 10; and

FIG. 12 is another diagram showing a usage of the infant car seat of FIG. 10.

### BEST MODE FOR CARRYING OUT THE INVENTION

First, a main body 10 of an infant car seat 70 according to the present invention is strapped to a seat of a car in common and known manner, and thus detailed description thereof will be omitted.

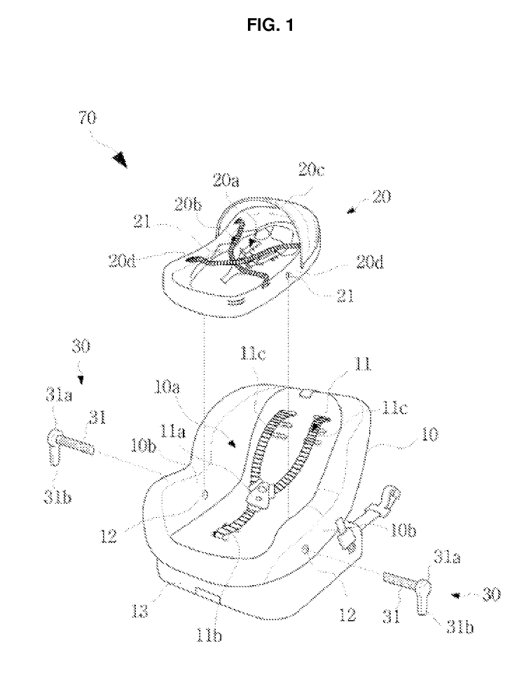

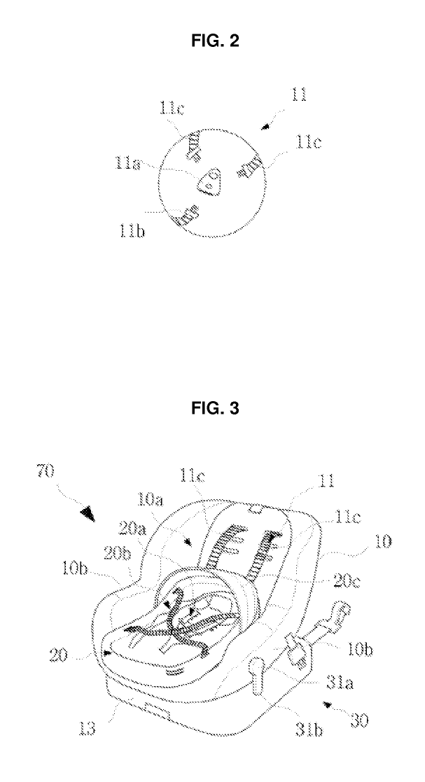

According to an embodiment of the present invention as shown in FIGS. 1 through 3, the infant car seat 70 according to the present invention includes the main body 10 that is strapped to a seat of a car, an infant carrier 20 accommodated in the main body 10, and a fixing unit 30 for fixing the infant carrier 20 in the main body 10. The infant carrier 20 is configured to be carried by user. According to an embodiment of the present invention, an infant safety belt unit 20a for fixing the main body of an infant, a handle 20b for carrying the infant carrier 20, and a foldable sunscreen 20c are installed on the infant carrier 20.

The infant carrier 20 is accommodated in a seat back portion 10a of the main body 10 on which a child may sit. The fixing unit 30 is a pair of attachment screws 31, at which levers 31 b are formed at their heads 31 a. Attachment hole 21, in which screw threads are formed on the inner circumferential surface, is formed in each side 20d of the left and right sides of the infant carrier 20. Attachment hole 12, in which screw threads are formed on the inner circumferential surface, is formed in each side 10b of the left and right sides of the main body 10. The attachment holes 12 and 21 are combined with each others by the attachment screws 31, respectively.

A safety belt unit 11 installed at the seat back portion 10a includes a center buckle 11a that may be completely detached from safety belts 11b, 11c, and 11d with clips in a manner known in the art.

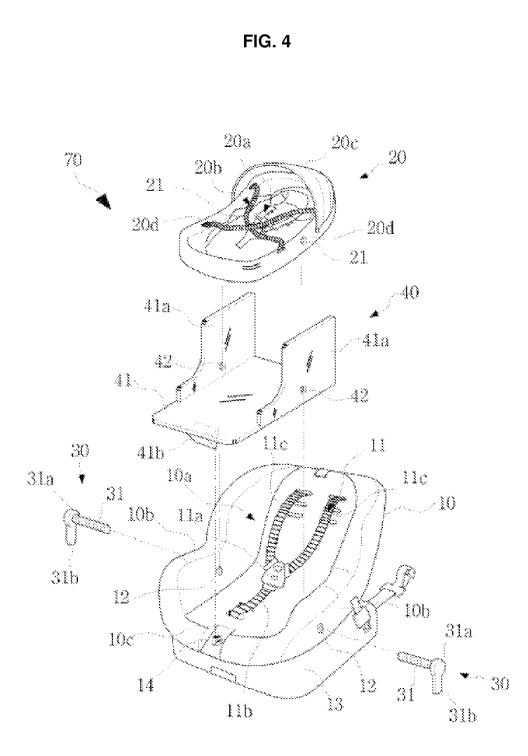

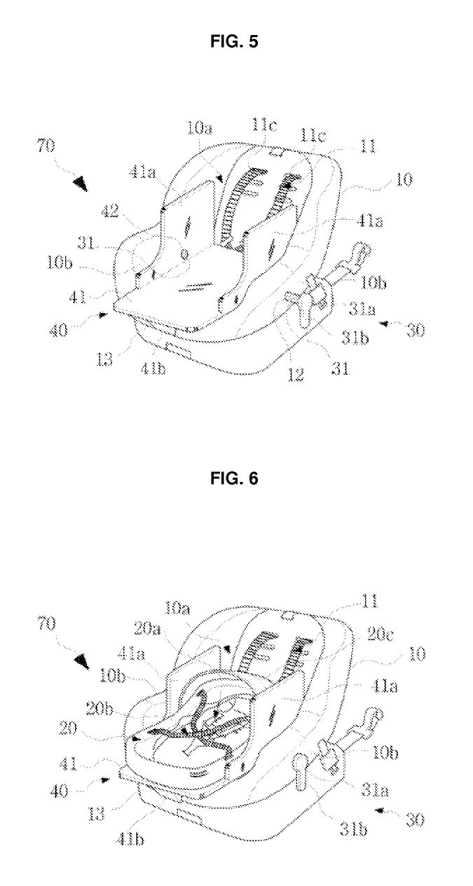

According to another embodiment of the present invention as shown in FIGS. 4 through 6, the infant car seat 70 includes the main body 10, which is fixed to a seat of a car, includes the seat back portion 10a for sitting a child thereon, a baby's diaper changing table 40 accommodated in the seat back portion 10a, the infant carrier 20 mounted on the baby's diaper changing table 40, and the fixing unit 30 for fixing the infant carrier 20 to the main body 10.

The fixing unit 30 is a pair of attachment screws 31, at which levers 31b are formed at their heads 31 a. The attachment hole 21, in which screw threads are formed to on the inner circumferential surface, is formed in each side 20d of the left and right sides of the infant carrier 20. The attachment hole 12, in which screw threads are formed on the inner circumferential surface, is formed in each side 10b of the left and right sides of the main body 10. The baby's diaper changing table 40 includes a worktable 41, which is formed to lay an infant thereon, and side protection plates 41a, which are formed at the left and right sides of the worktable 41. Attachment hole 42, in which screw threads are formed on the inner circumferential surface, is formed in each of the left and right sides protection plates 41a. The attachment holes 12, 42, and 21 are combined with each others by the attachment screws 31, respectively.

A supporting base 41b, which protrudes downward, is formed on the bottom surface of the worktable 41 of the baby's diaper changing table 40, whereas an insertion groove 14, to which the lower portion of the supporting base 41b is inserted, is formed on the top surface of the front portion of the main body 10.

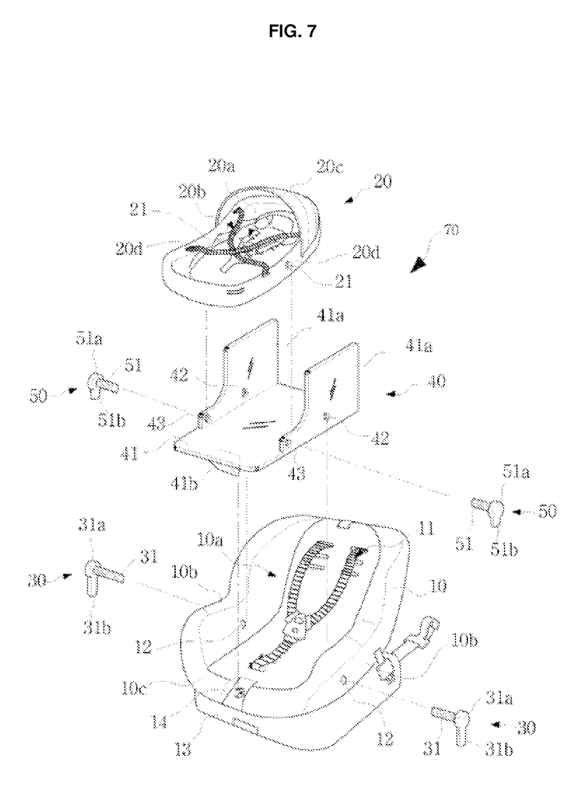

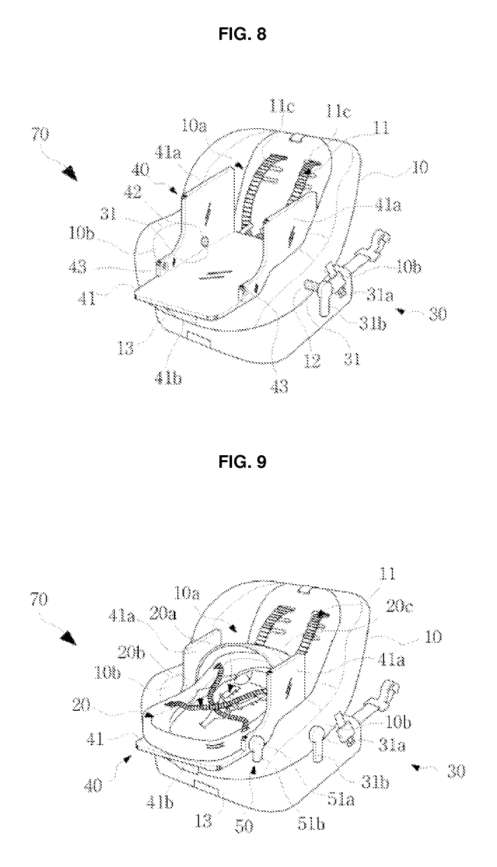

According to another embodiment of the present invention as shown in FIGS. 7 through 9, the infant car seat 70 includes the main body 10, which is fixed to a seat of a car, includes the seat back portion 10a for sitting a child thereon, the baby's diaper changing table 40 accommodated in the seat back portion 10a, the infant carrier 20 mounted on the baby's diaper changing table 40, the fixing unit 30 for fixing the infant carrier 20 to the main body 10, and a fixing unit 50 for fixing the infant carrier 20 to the baby's diaper changing table 40.

The fixing unit 30 is a pair of attachment screws 31, at which levers 31b are formed at their heads 31a. The attachment hole 12, in which screw threads are formed on the inner circumferential surface, is formed in each side 10b of the left and right sides of the main body 10. The baby's diaper changing table 40 includes the worktable 41, which is formed to lay an infant thereon, and the side protection plates 41a, which are formed upward at the left and right sides of the worktable 41. The attachment hole 42, in which screw threads are formed on the inner circumferential surface, is formed in each of the left and right sides protection plates 41a. The attachment holes 12 and 42 are combined with each others by the attachment screws 31, respectively. The fixing unit 50 is a pair of attachment screws 51, at which levers 51 b are formed at their heads 51a. The attachment hole 21, in which screw threads are formed on the inner circumferential surface, is formed in each side 20b of the left and right sides of the infant carrier 20. Attachment hole 43, in which screw threads are formed on the inner circumferential surface, is formed in each side of the front portion of the left and right sides protection plates 41a. The attachment holes 21 and 43 are combined with each others by the attachment screws 51, respectively.

The supporting base 41b, which protrudes downward, is formed on the bottom surface of the worktable 41 of the baby's diaper changing table 40, whereas the insertion groove 14, to which the lower portion of the supporting base 41b is inserted, is formed on the top surface of the front portion of the main body 10.

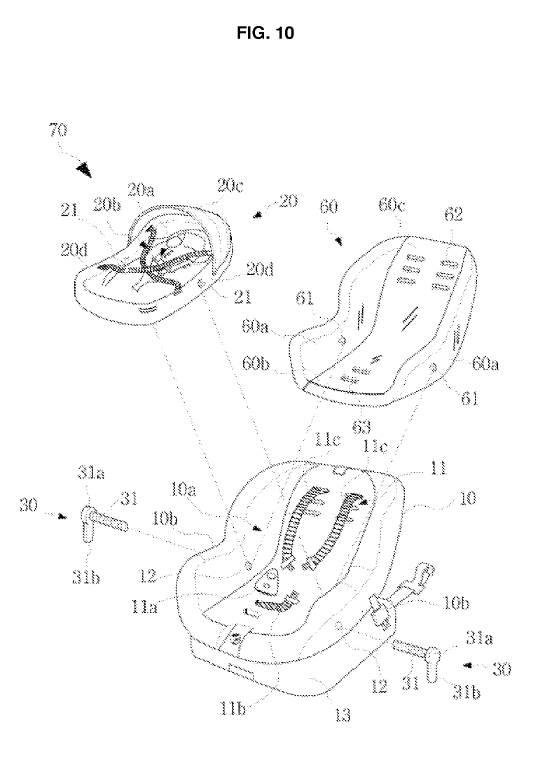

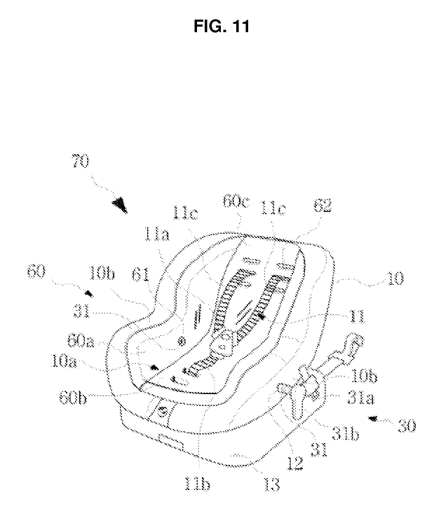

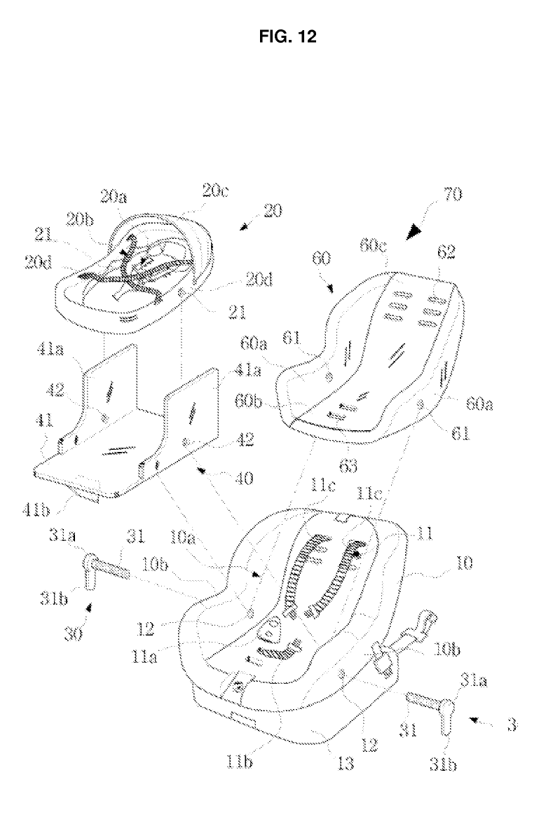

According to another embodiment of the present invention as shown in FIGS. 10 through 12, the infant car seat 70 includes an auxiliary seat back 60, which is accommodated in the seat back portion 10a and is fixed by the fixing unit 30.

The auxiliary seat back 60 includes a seat portion 60b on which a child may sit, a backrest portion 60c which extends upward from the rear portion of the seat portion 60b to which the child may rest his or her back, and each side panels 60a formed at the left and right sides of the seat portion 60b and the backrest portion 60b. The fixing unit 30 is a pair of attachment screws 31, at which levers 31b are formed at their heads 31a.

The attachment hole 12, in which screw threads are formed on the inner circumferential surface, is formed in each side 10b of the left and right sides of the main body 10.

Attachment hole 61, in which screw threads are formed on the inner circumferential surface, is formed in each of the locations on the side panels 60b in correspondence to the attachment holes 12. The attachment holes 12 and 61 are combined with each others by the attachment screws 31, respectively.

The unexplained reference numeral 13 denotes a base portion.

According to the above embodiments of the present invention, the infant car seats as described above have effects as described below.

When a child is too young to hold his/her head up yet and it is necessary to lay the child in a car while a user is driving, the infant car seat 70 according to the embodiment of the present invention as shown in FIGS. 1 through 3 is fixed to a seat of a car in the known manner, the center buckle 11a of the safety belt unit 11 installed at the seat back portion 10a of the main body 10 of the infant car seat 70, on which a child sits, is detached, the infant carrier 20 is accommodated in the seat back portion 10a, and the infant carrier 20 is fixed thereto by inserting the attachment screws 31 to the left and right sides of the main body 10.

In the embodiments as respectively shown in FIGS. 4 through 6 and FIGS. 7 through 9, the baby's diaper changing table 40 is accommodated in the seat back portion 10a and is fixed by the attachment screws 31. When a child soils baby's diaper, the infant carrier 20 can be detached from the seat back portion 10a by unscrewing the attachment screws 31 and the child can be laid on the baby's diaper changing table 40 for baby's diaper replacement in sanitary and convenient way.

In the embodiment shown in FIGS. 10 through 12, even if a child has grown enough and the infant carrier 20 is no longer needed, if the seat back portion 10a formed at the main body 10 of the infant car seat 70 is still bigger than the frame of the child, the auxiliary seat back 60 for stably fixing the child can be accommodated in the seat back portion 10a and fixed with the attachment screws 31.

According to the present invention, when a child is too young to hold his/her head up, a user could move the child outside a car with the lightweight infant carrier 20, and the infant carrier 20 can be fixed to the infant car seat 70 with the fixing unit 30 when the user drives the car. If the child soils a baby's diaper, the baby's diaper changing table 40 can be used. When the child has grown enough to walk by himself or herself and become too big for the infant carrier, if the child is still too small to be comfortably fit to the seat back portion 10a of the infant car seat 70, the child can be stably fixed with the auxiliary seat back 60. Therefore, it is not necessary to purchase an infant carrier and an infant car seat separately.

### INDUSTRIAL APPLICABILITY

The present invention relates to an infant car seat, and more particularly, and can be applied to an infant car seat, which includes an infant carrier that is accommodated in and detachably fixed to the main body.

1. An infant car seat to be strapped to a seat of a car, the infant car seat comprising:
a main body to be strapped to a seat of a car;
an infant carrier accommodated in the main body; and
a fixing unit for fixing the infant carrier to the main body.

2. The infant car seat of claim 1, wherein the infant carrier is accommodated in a seat back portion that is formed at the main body for sitting a child thereon,
the fixing unit is a pair of attachment screws at which levers are formed at their heads,
a first attachment hole, in which screw threads are formed on the inner circumferential surface, is formed in each side of the left and right sides of the infant is carrier,
a second attachment hole, in which screw threads are formed on the inner circumferential surface, is formed in each side of the left and right sides of the main body, and
the first attachment holes and the second attachment holes are combined with each others by the attachment screws, respectively.

3. The infant car seat of claim 2, further comprising an auxiliary seat back, which is accommodated in the seat back portion and is fixed by the fixing unit.

4. An infant car seat to be strapped to a seat of a car, the infant car seat comprising:
a main body, which is to be strapped to the seat of a car and includes a seat back portion that is formed at the main body for sitting a child thereon;
a baby's diaper changing table accommodated in the seat back portion;
an infant carrier mounted on the baby's diaper changing table; and
a fixing unit for fixing the baby's diaper changing table and the infant carrier to the main body.

5. The infant car seat of claim 4, wherein the fixing unit is a pair of attachment screws, at which levers are formed at their heads,
a first attachment hole, in which screw threads are formed on the inner circumferential surface, is formed in each side of the left and right sides of the infant carrier,
a second attachment hole, in which screw threads are formed on the inner circumferential surface, is formed in each side of the left and right sides of the main body,
the baby's diaper changing table comprises a worktable, which is formed to lay an infant thereon, and side protection plates, which are formed at both sides ends of the to worktable,
a third attachment hole, in which screw threads are formed on the inner circumferential surface, is formed in each of the left and right sides protection plates, and the first attachment holes, the second attachment holes, and the third attachment holes are combined with each others by the attachment screws, respectively.

6. An infant car seat to be strapped to a seat of a car, the infant car seat comprising:
a main body, which is to be strapped to the seat of a car and includes a seat back portion that is formed at the main body for sitting a child thereon;
a baby's diaper changing table accommodated in the seat back portion;
an infant carrier mounted on the baby's diaper changing table;
a first fixing unit for fixing the baby's diaper changing table and the infant carrier to the main body; and
a second fixing unit for fixing the infant carrier to the baby's diaper changing table.

7. The infant car seat of claim 6, wherein the fixing unit is a pair of attachment screws, at which levers are formed at their heads,
a first attachment hole, in which screw threads are formed on the inner circumferential surface, is formed in each side of the left and right sides of the main body,
the baby's diaper changing table includes a worktable, which is formed to lay an infant thereon, and side protection plates, which are formed upward at both sides of the worktable,
a second attachment hole, in which screw threads are formed on the inner circumferential surface, is formed in each of the left and right sides protection plates,
a first attachment holes and the second attachment holes are combined with each others by the attachment screws, respectively,
the fixing unit is a pair of attachment screws, at which levers are formed at their heads,
a third attachment hole, in which screw threads are formed on the inner circumferential surface, is formed in each side of the left and right sides of the infant carrier,
a fourth attachment hole, in which screw threads are formed on the inner circumferential surface, is formed in each side of each front portion of the left and right sides protection plates, and
the third attachment holes and the fourth attachment holes are combined with each others by the attachment screws, respectively.

8. The infant car seat of claim 4, further comprising a supporting base that protrudes downward and is formed on the bottom surface of the worktable of the baby's diaper changing table, whereas an insertion groove, to which the lower portion of the supporting base is inserted, is formed on the top surface of the front portion of the main body.

9. The infant car seat of 4, further comprising an auxiliary seat back, which is accommodated in the seat back portion and is fixed by the fixing unit.

10. The infant car seat of claim 9, wherein the auxiliary seat back comprises:
a seat portion on which a child may sit;
a backrest portion which extends upward from the rear portion of the seat portion to which the child may rest his or her back; and
each side panels formed at the left and right sides of the seat portion and the backrest portion,
the fixing unit is a pair of attachment screws, at which levers are formed at their heads,
a first attachment hole, in which screw threads are formed on the inner circumferential surface, is formed in each side of the left and right sides of the main body,
a second attachment hole, in which screw threads are formed on the inner circumferential surface, is formed in each of the locations on the left and right sides panels in correspondence to the attachment holes, and the first attachment holes and the second attachment holes are combined with each others by the attachment screws, respectively.
